(19) United States
(12) Patent Application Publication
(10) Pub. No.: US 2023/0086771 A1
(43) Pub. Date: Mar. 23, 2023

(54) DATA MANAGEMENT SYSTEM, DATA MANAGEMENT METHOD, AND DATA MANAGEMENT PROGRAM

(71) Applicant: NEC Corporation, Minato-ku, Tokyo (JP)

(72) Inventor: Hiroki YOKOYAMA, Tokyo (JP)

(73) Assignee: NEC Corporation, Minato-ku, Tokyo (JP)

(21) Appl. No.: 17/802,016

(22) PCT Filed: Feb. 15, 2021
(86) PCT No.: PCT/JP2021/005524

§ 371 Date: Aug. 24, 2022

(30) Foreign Application Priority Data
Mar. 13, 2020 (JP) 2020-043887

(51) Int. Cl. H04L 9/40; G06F 21/45

(52) U.S. Cl. CPC H04L 63/108; G06F 21/45

(57) ABSTRACT

The data management system 80 manages data of users who use a facility. The arrival time prediction unit 81 predicts an arrival time of the user at the facility. The registration unit 82 acquires authentication data used for authentication of the user from an external device based on the predicted arrival time and registers it in a local storage device. The exit time prediction means 83 predicts an exit time of the user from the facility. The deletion means 84 deletes the authentication data from the storage device after the predicted exit time of the user.

### TECHNICAL FIELD

This invention relates to a data management system, a data management method, and a data management program for managing locally stored data.

### BACKGROUND ART

In recent years, systems using face authentication have become popular for security and convenience reasons. For example, in order to solve the future issue of a decrease in the number of employees due to a shrinking population, demonstration tests of unmanned stores are underway in convenience stores, and face authentication is being used to manage store entry and exit and for payment.

When face authentication is used in unmanned stores, response performance is required from the perspective of convenience. In addition, if unmanned stores become widespread, the database is expected to become bloated as the number of users increases. Therefore, it is assumed that the database will be managed in the cloud, some data will be downloaded to edge devices and other devices installed in the stores, and face authentication will be performed in the stores to improve response performance.

On the other hand, since the downloaded data is used for shop entry/exit and payment, it includes payment information such as credit card information in addition to biometric information. Therefore, when face authentication is used for shop entry/exit and payment in unmanned stores, the data must be managed from the perspective of privacy and security. For example, if a device in a store is stolen, temporarily downloaded biometric information or credit card information may be leaked and misused by a malicious person. Therefore, it is necessary to replace temporarily downloaded data at the appropriate time.

Patent Literature 1 describes a face authentication database management method that manages face image data used for face authentication by associating them with user IDs. In the method described in Patent Literature 1, face image data is deleted from the face authentication database based on the authentication usage level, which indicates the usage level of face image data used to determine face authentication in the past, and newly detected face image data is registered.

In addition, Patent Literature 2 describes an information processing system using face authentication. In the system described in Patent Literature 2, the center server provides the registered face information to the store server’s database in response to an inquiry from the store server, and the store server deletes the customer’s visitor information from the database after confirming that the customer has left the store or that a predetermined amount of time has passed.

### CITATION LIST

### Patent Literature

PTL 1: Japanese Patent Application Laid-Open No.2013-77068
PTL 2: Japanese Patent Application Laid-Open No.2018-101420

### SUMMARY OF INVENTION

### Technical Problem

On the other hand, in the method described in Patent Literature 1, data is not deleted from the store’s device unless face authentication is performed (i.e., data is not deleted until a person enters the store). Also, in the method described in Patent Document 1, data is not deleted until a certain number of people enter the store, because data is deleted after the storage area runs out of space. Furthermore, in the method described in Patent Literature 1, only the face image with the oldest registration time is deleted, even after the user has left the store. Therefore, the biometric information and payment information of users who have used the store in the past will continue to remain on the local store’s device, and if this device is stolen, the information may be leaked and misused.

In the system described in Patent Literature 2, after extracting the visitor’s face information from the captured image, the registered face information to be used for face authentication is obtained from the center server. In this way, it is difficult to maintain the response time for face authentication because it takes time to authenticate a face in this method, which requires a query to the center server for each authentication.

Therefore, it is an exemplary object of the present invention to provide a data management system, a data management method, and a data management program that can appropriately manage data used for local authentication while maintaining response during authentication.

### Solution to Problem

A data management system according to the exemplary aspect of the present invention is a system for managing data of users who use a facility, the data management system includes: an arrival time prediction means which predicts an arrival time of the user at the facility; a registration means which acquires authentication data used for authentication of the user from an external device based on the predicted arrival time and registers it in a local storage device; an exit time prediction means which predicts an exit time of the user from the facility; and a deletion means which deletes the authentication data from the storage device after the predicted exit time of the user.

A data management method according to the exemplary aspect of the present invention is a method for managing data of users who use a facility, the data management method includes: predicting an arrival time of the user at the facility; acquiring authentication data used for authentication of the user from an external device based on the predicted arrival time and registering it in a local storage device; predicting an exit time of the user from the facility; and deleting the authentication data from the storage device after the predicted exit time of the user.

A data management program according to the exemplary aspect of the present invention is a program applied to a computer that manages data of users who use a facility, the data management program causes a computer to execute, an arrival time prediction processing of predicting an arrival time of the user at the facility; a registration processing of acquiring authentication data used for authentication of the user from an external device based on the predicted arrival time and registering it in a local storage device; an exit time prediction processing of predicting an exit time of the user from the facility; and a deletion processing of deleting the authentication data from the storage device after the predicted exit time of the user.

### ADVANTAGEOUS EFFECTS OF INVENTION

According to the present invention, it is possible to appropriately manage data used for local authentication while maintaining response during authentication.

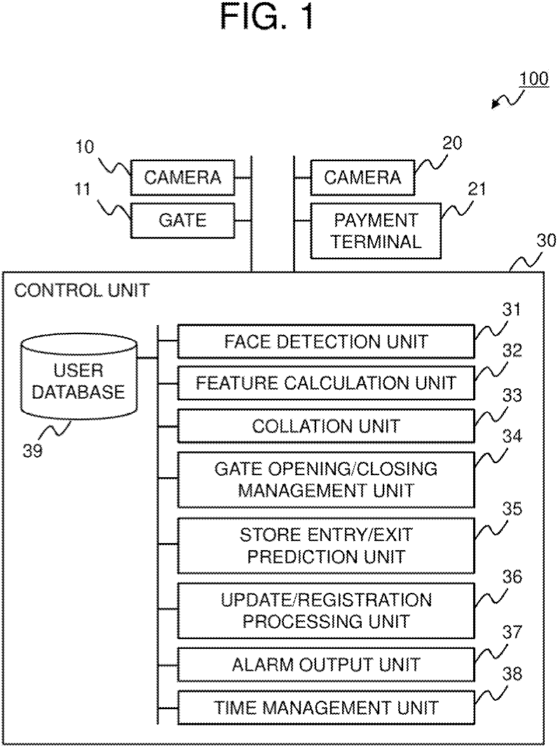

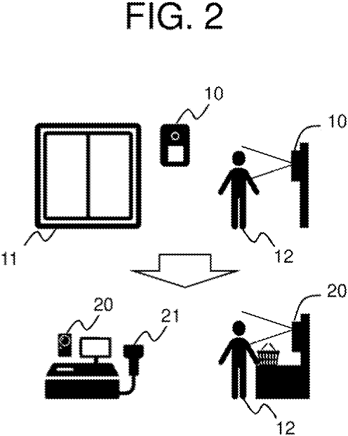

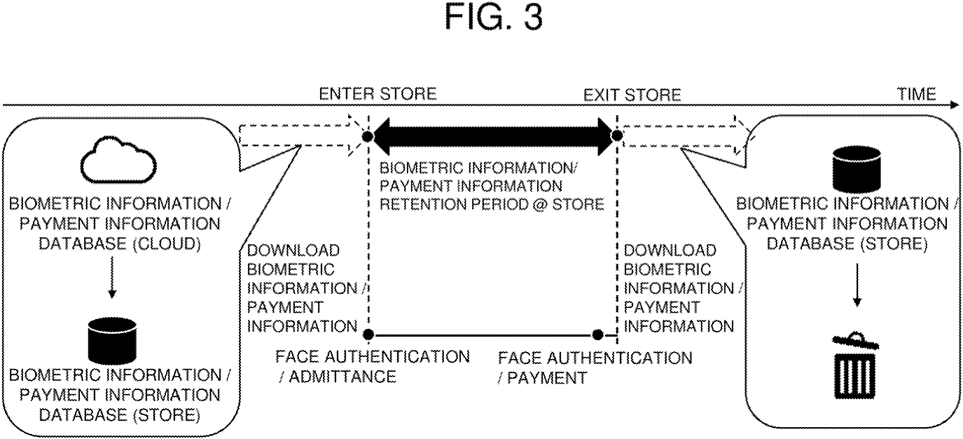

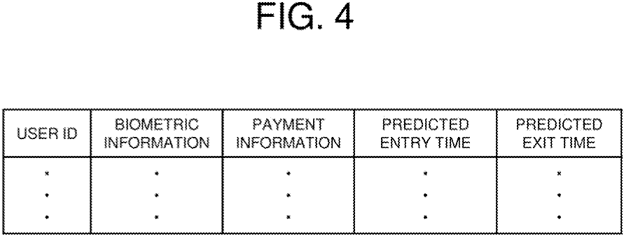

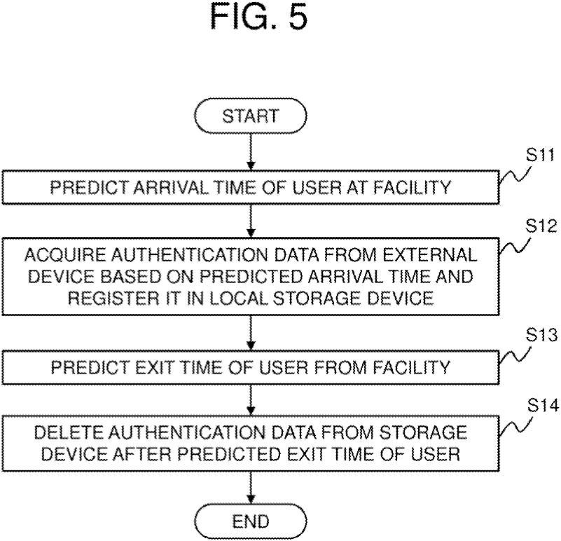

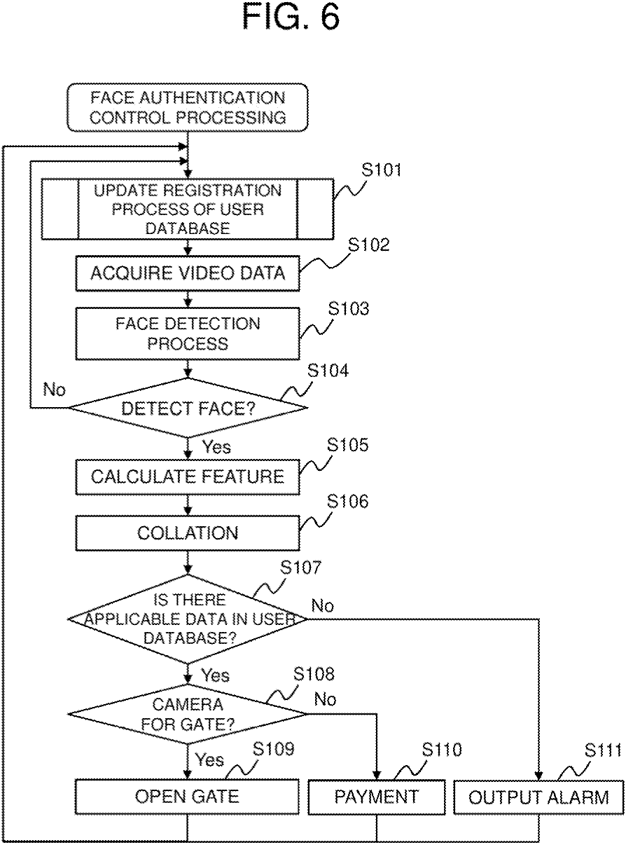

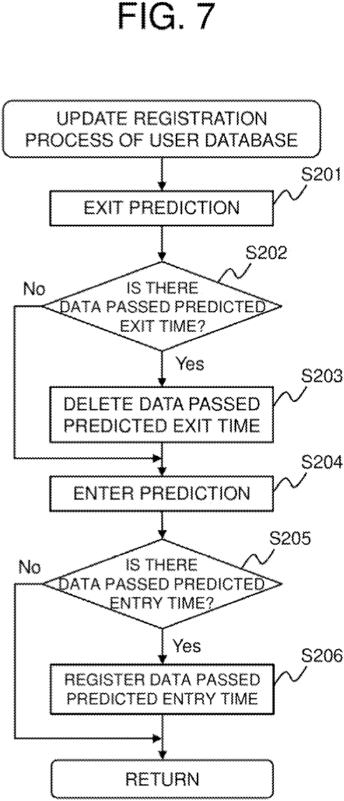

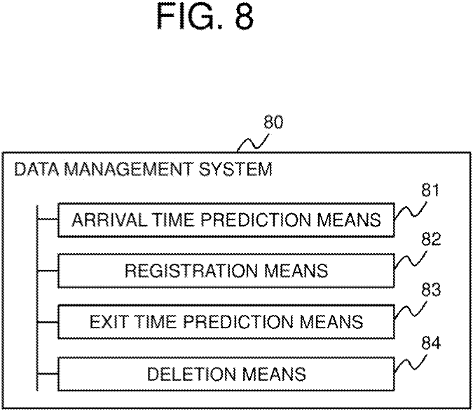

### BRIEF DESCRIPTION OF DRAWINGS

[FIG. 1] It depicts a block diagram illustrating a configuration example of a data management system according to the present invention.

[FIG. 2] It depicts an explanatory diagram illustrating an example of the process of authenticating a user.

[FIG. 3] It depicts an explanatory diagram illustrating an example of the process of retaining data.

[FIG. 4] It depicts an explanatory diagram illustrating an example of information stored in a user database.

[FIG. 5] It depicts a flowchart illustrating an overview of the operation of the data management system.

[FIG. 6] It depicts a flowchart illustrating an example of the operation of the data management system.

[FIG. 7] It depicts a flowchart illustrating an example of the update registration process for the user database.

[FIG. 8] It depicts a block diagram showing an overview of a data management system according to the present invention.

### DESCRIPTION OF EMBODIMENTS

Hereinafter, exemplary embodiments of the present invention will be described with reference to appended drawings. This exemplary embodiment describes a system that manages data of customers using unmanned stores as an example of a system that locally manages data of users using a facility. Specifically, this exemplary embodiment describes a system that manages entry and exit from a store based on biometric information. However, the facilities where this invention is used are not limited to stores, but may be, for example, venues where conventions, concerts, etc. are held. Furthermore, in this exemplary embodiment, the method of managing user payments based on the information used for payment (hereinafter referred to as “payment information”) is also described.

FIG. 1 a block diagram illustrating a configuration example of a data management system according to the present invention. The data management system 100 in this exemplary embodiment includes a camera 10 and a gate 11 near an entrance to a facility. The data management system 100 in this exemplary embodiment also includes a camera 20 and a payment terminal 21 near an exit of the facility. Furthermore, the data management system 100 in this exemplary embodiment includes a control unit 30 that controls these devices.

The camera 10 is a device that acquires biometric information of the user at the time of admission, and in this exemplary embodiment, the camera 10 captures the user’s face image. Other information other than the face image (e.g., fingerprints, voice prints, etc.) may be used as the biometric information of the user. In such a case, the data management system 100 may include an appropriate sensor (e.g., fingerprint authentication device, microphone, etc.) instead of the camera 10. Therefore, the camera 10 that acquires the biometric information of the user can be referred to as a biometric information acquisition device. The camera 10 transmits the acquired face image to the control unit 30. At this time, the camera 10 may transmit information identifying itself (e.g., IP address or camera ID).

The gate 11 is a device that operates under the control of the control unit 30 (specifically, a gate opening/closing management unit 34 and an alarm output unit 37) described below. The control method of the gate 11 is described below.

The camera 20 is a device that acquires biometric information of the user during payment at the facility, and in this exemplary embodiment, the camera 20 captures the user’s face image. As with the camera 10, other sensors may be used depending on the biometric information to be acquired. Therefore, the camera 20 can also be referred to as a biometric information acquisition device. At this time, the camera 20 may also transmit information identifying itself (e.g., IP address or camera ID) together.

The payment terminal 21 is a device that uses biometric information to make payments for users. Specifically, the payment terminal 21 authenticates the user based on biometric information and make payments for users based on the payment information. The content of the payment processing performed by the payment terminal 21 is not limited. The payment terminal 21 in this exemplary embodiment may also output an alarm when payment cannot be made, under the control of the alarm output unit 37 described below.

FIG. 2 is an explanatory diagram illustrating an example of the process of authenticating a user. The camera 10 installed at the entrance/exit of the store captures the image of the user 12, and as a result of authentication (matching with biometric information) by the control unit 30 described below, the process of opening and closing gate 11 is performed. The camera 20 installed at the store cash register captures the image of the user 12, and as a result of authentication (matching with biometric information) by the control unit 30 described below, the payment is made at the payment terminal 21.

The control unit 30 includes a face detection unit 31, a feature calculation unit 32, a collation unit 33, a gate opening/closing management unit 34, a store entry/exit prediction unit 35, an update/registration processing unit 36, an alarm output unit 37, a time management unit 38, and a user database 39.

The face detection unit 31 detects the user’s face, which is biometric information of the user, from the images captured by the camera 10 and the camera 20. The feature calculation unit 32 calculates feature from the detected user faces. The collation unit 33 collates the calculated feature and the biometric information stored in the user database 39 described below to determine whether or not a matching user exists. If there is a user whose authentication data stored in the user database 39 and the calculated feature match, the collation unit 33 may determine that the authentication of the user is successful and allow admission and payment processing. The method of detecting a person’s face from an image and calculating and matching feature is widely known, so a detailed explanation is omitted here.

In addition, when other information other than face images (e.g., fingerprints, voice prints, etc.) is used as biometric information in this exemplary embodiment, the face detection unit 31, the feature calculation unit 32, and the collation unit 33 may extract the feature corresponding to the respective biometric information and perform matching.

The gate opening/closing management unit 34 manages the opening and closing of the gate 11. Specifically, the gate opening/closing management unit 34 may instruct the gate 11 to open when the collation unit 33 determines that the user has been successfully authenticated, or may instruct the gate 11 not to open when the collation unit 33 determines that the user has not been successfully authenticated.

The store entry/exit prediction unit 35 predicts an arrival time of the user at the facility and an exit time of the user from the facility. In this exemplary embodiment, the store entry/exit prediction unit 35 predicts the entry time and the exit time of the user. Since the store entry/exit prediction unit 35 predicts the arrival time of the user at the facility and the exit time of the user from the facility, the store entry/exit prediction unit 35 can be referred to as an arrival time prediction unit and an exit time prediction unit.

As described above, the store entry/exit prediction unit 35 predicts the arrival time (entry time) of the user to the facility (store). The method by which the store entry/exit prediction unit 35 predicts the arrival time is arbitrary. For example, the store entry/exit prediction unit 35 may predict the entry time of a user using a model that predicts store entry based on the user’s attribute information and regularity. Examples of attribute information include location information and preferences. Examples of regularity include purchase information and weather conditions. In the case of a venue for an event, the store entry/exit prediction unit 35 may predict the arrival time of users based on time schedules such as opening times and show times.

Similarly, the store entry/exit prediction unit 35 predicts the use’s exit time from the facility(store). The method by which the store entry/exit prediction unit 35 predicts the exit time is also arbitrary. Similar to the prediction of entry time, the store entry/exit prediction unit 35 may predict the user’s exit time using a model that predicts store exit based on the user’s attribute information and regularity. The store entry/exit prediction unit 35 may, for example, have machine-learned prediction models for the time spent at a facility by age and/or gender. In this case, the store entry/exit prediction unit 35 may obtain the user’s age and/or gender at the time of entry and predict the exit time based on the obtained information and the learned prediction model. The age and/or gender of the user may be estimated, for example, from an image captured by the camera 10, or may be obtained from registered information.

Otherwise, the store entry/exit prediction unit 35 may, for example, predict the exit time after a user enters a facility (store), based on the results of the user’s flow line analysis or post-payment regularity (e.g., the user leaves the store a few minutes after payment, etc.). The flow line analysis includes, for example, moving time and staying time in the store. In the case of a venue for an event, for example, the store entry/exit prediction unit 35 may predict the exit time of users based on a time schedule, such as closing time or closing time of a show.

The update/registration processing unit 36 performs update and registration processing of the user database 39. Specifically, the update/registration processing unit 36 obtains data used to authenticate the user (hereinafter referred to as authentication data) based on the predicted arrival time from an external device (not shown) and registers it in the local storage device (e.g., user database 39). An example of authentication data is the user’s biometric information (e.g., facial features). The update/registration processing unit 36 also obtains the user’s payment information from the external device along with the user’s authentication data.

The external device is, for example, a device connected to a Wide Area Network (WAN) (i.e., not local), an example being a cloud server. The local storage device is, for example, a storage server connected to a Local Area Network (LAN) in a facility, or a IoT (Internet of Things) gateway. In other words, in this exemplary embodiment, since the amount of data to be stored locally is small, the local storage device can be realized in an IoT gateway with a small device size and capacity.

The update/registration processing unit 36 may acquire authentication data and payment information from the external device at the predicted arrival time or after the predicted arrival time. If the authentication data is required at the predicted arrival time, it may be acquired before the predicted entry time by a predetermined period of time.

The update/registration processing unit 36 also deletes authentication data (and payment information, if present) from the storage device (e.g., the user database 39) after the predicted exit time. The update/registration processing unit 36 may delete the authentication data and payment information from the external device when the predicted exit time is reached, or before a predetermined period of time has elapsed from the predicted exit time.

Thus, since the update/registration processing unit 36 of this exemplary embodiment registers and deletes authentication data and payment information, the update/registration processing unit 36 can be referred to as a registration unit and a deletion unit.

FIG. 3 is an explanatory diagram illustrating an example of the process of retaining data in a storage device. Initially, the user’s biometric information and payment information are not stored in a storage device in the store. In this state, first, the biometric information and payment information are downloaded from the database (cloud) to the storage device in the store based on the predicted arrival time of the user.

When the user arrives at the store at the predicted arrival time, face authentication is performed using the downloaded biometric information and admission is granted. The data is retained in the storage device in the store for the period of time that the user is predicted to be in the store (i.e., only when staying in the store). Then, after the payment is made by facial authentication and the user exits the store, the biometric information and payment information stored in the storage device in the store are replaced (deleted) at the predicted exit time.

In this way, the biometric information and payment information are stored in the store only during the predicted length of stay, thus maintaining response during authentication and retaining the data used for local authentication for the minimum necessary period.

The alarm output unit 37 controls the output of alarms to the gate 11 and the payment terminal 21. Specifically, the alarm output unit 37 controls the output of alarms to the gate 11 and payment terminal 21 when a user cannot be authenticated or a payment cannot be made. For example, the alarm output unit 37 may control output of alarms when the collation unit 33 determines that a user with matching biometric information does not exist in the user database 39.

The user database 39 is a database that stores various information about users. In this exemplary embodiment, the user database 39 stores biometric information and payment information of the user. In addition, the user database 39 stores the predicted arrival time of the user (predicted entry time) and the predicted exit time of the user (predicted exit time). The arrival time and exit time are registered by the update/registration processing unit 36 with the times predicted by the store entry/exit prediction unit 35.

FIG. 4 is an explanatory diagram illustrating an example of information stored in a user database 39. “User ID” is a field that stores an ID that uniquely identifies the user. “Biometric information” is a field that stores the user’s biometric information (e.g., characteristics). “Payment information” is a field that stores the user’s payment information (e.g., credit card number). “Predicted entry time” is a field that stores the predicted entry time of the user. “Predicted exit time” is a field that stores the predicted exit time of the user. The user database 39 is realized by, for example, a magnetic disk.

The time management unit 38 manages the entry time and exit time of users. For example, the time management unit 38 may notify each configuration included in the control unit 30 when it is time to enter or exit the store as registered in the user database 39. The time management unit 38 may notify when a predetermined time before the entry time, or when a predetermined time after the exit time has elapsed.

The control unit 30 (more specifically, the face detection unit 31, the feature calculation unit 32, the collation unit 33, the gate opening/closing management unit 34, the store entry/exit prediction unit 35, the update/registration processing unit 36, the alarm output unit 37, and the time management unit 38) is realized by a processor (for example, CPU (Central Processing Unit), GPU (Graphics Processing Unit)) of a computer that operates according to a program (a data management).

For example, a program may be stored in a storage unit (not shown) in the data management system 100, and the processor may read the program and operate as the control unit 30 (more specifically, the face detection unit 31, the feature calculation unit 32, the collation unit 33, the gate opening/closing management unit 34, the store entry/exit prediction unit 35, the update/registration processing unit 36, the alarm output unit 37, and the time management unit 38) according to the program. In addition, the functions of the data management system 100 may be provided in the form of SaaS (Software as a Service).

The control unit 30 (more specifically, the face detection unit 31, the feature calculation unit 32, the collation unit 33, the gate opening/closing management unit 34, the store entry/exit prediction unit 35, the update/registration processing unit 36, the alarm output unit 37, and the time management unit 38) may each be realized by dedicated hardware. Some or all of the components of each device may be realized by general-purpose or dedicated circuit, a processor, or combinations thereof. These may be configured by a single chip or by multiple chips connected through a bus. Some or all of the components of each device may be realized by a combination of the above-mentioned circuit, etc., and a program.

When some or all of the components of the data management system 100 are realized by multiple information processing devices, circuits, etc., the multiple information processing devices, circuits, etc. may be centrally located or distributed. For example, the information processing devices, circuits, etc. may be realized as a client-server system, a cloud computing system, etc., each of which is connected through a communication network.

Next, the operation example of this exemplary embodiment will be described. First, an overview of the operation of the data management system 100 in this exemplary embodiment is described at the beginning. FIG. 5 is a flowchart illustrating an overview of the operation of the data management system 100. The store entry/exit prediction unit 35 predicts an arrival time of users at the facility (step S11). The update/registration processing unit 36 acquires authentication data from an external device and registers it in a local storage device based on the predicted arrival time (step S12). Thereafter, the store entry/exit prediction unit 35 predicts an exit time of the user from the facility (step S13), and the update/registration processing unit 36 deletes the authentication data from the storage device after the predicted exit time of the user (step S 14).

FIG. 6 is a flowchart illustrating an example of the operation of the data management system 100 according to the present exemplary embodiment. Here, a store is assumed as the facility, and face authentication is assumed as the authentication method. In addition, biometric information and payment information are assumed as data to be registered and deleted in the user database 39.

After the start of the face authentication control process, the update/registration processing unit 36 performs the update/registration process of the user database 39 (step S1 01). The details of the update/registration process are described below. Next, the camera 10 attached to the gate 11 or the camera 20 attached to the payment terminal 21 acquires the captured video and inputs it to the control unit 30 (step S102). The face detection unit 31 performs a process to detect the face of store users based on the input video (step S103). If no face is detected (No in step S104), the process from step S103 onward is repeated.

On the other hand, if a face is detected (Yes in step S104), the feature calculation unit 32 calculates feature of the detected face (Step S105). Then, the collation unit 33 searches the user database 39 based on the calculated feature and performs collation (Step S106).

If there is no applicable data in the user database (No in step S107), the alarm output unit 37 controls the alarm output to the gate 11 and the payment terminal 21 (Step S111). The gate 11 or the payment terminal 21 may notify the user of the non-authentication based on the control by the alarm output unit 37. For example, a display or LED (Light Emitting Diode) attached to the gate, a display on the payment terminal, or any other terminal that is visible to the user may indicate that an error has occurred.

On the other hand, if there is applicable data in the user database (Yes in step S107), the gate opening/closing management unit 34 determines whether or not the camera that captured the image is a camera for the gate (Step S108). The gate opening/closing management unit 34 may, for example, determine the camera based on the IP address or camera ID.

If the camera that captured the image is a camera for the gate (Yes in step S108), the gate opening/closing management unit 34 controls the gate 11 to open the gate (Step S109). On the other hand, if the camera that captured the image is not a camera for the gate (No in step S 108), the update/registration processing unit 36 sends the payment information to the payment terminal 21, and the payment terminal 21 performs the payment processing (Step S110).

Thereafter, the process from step S101 onward is repeated.

FIG. 7 is a flowchart illustrating an example of the update registration process for the user database 39. Again, a store is assumed as the facility, and the user information is managed in the user database 39 exemplary illustrated in FIG. 4. When the update registration process starts, the store entry/exit prediction unit 35 makes an exit prediction (step S201), and the update/registration processing unit 36 registers the prediction results in the predicted exit time in the user database 39. The store entry/exit prediction unit 35 may also determine the exit of the user by face authentication at the exit.

After predicting the exit, the time management unit 38 checks the predicted exit time for each user in the user database 39. If there is data for which the predicted exit time has passed (Yes in step S202), the update/registration processing unit 36 deletes the data of users whose predicted exit time has passed (step S203). On the other hand, if there is no data for which the predicted exit time has passed (No in step S202), the following steps S204 and subsequent processes are performed.

The store entry/exit prediction unit 35 makes an enter prediction (step S204), and the update/registration processing unit 36 registers the prediction results in the predicted entry time in the user database 39. After making an enter prediction, the time management unit 38 checks the predicted entry time for each user in the user database 39. If there is data for which the predicted entry time has passed (Yes in step S205), the update/registration processing unit 36 registers the data of users whose predicted entry time has elapsed (step S206), and returns to step S102 as illustrated in FIG. 6 (step S207). On the other hand, if there is no data for which the predicted entry time has passed (No in step S205), the process returns in the same manner (step S207).

It is assumed that the user will continue to remain in the facility even though the predicted exit time has been exceeded. In this case, the authentication data is deleted from the local storage device (user database 39). Therefore, the collation unit 33 may determine that authentication is not possible when the user tries to perform the payment process. If the user tries to leave the facility without performing the payment process after the predicted exit time has passed, the collation unit 33 may not need to perform any processing.

As described above, in this exemplary embodiment, the store entry/exit prediction unit 35 predicts an arrival time of users at the facility, and the update/registration processing unit 36 acquires authentication data from an external device based on the predicted arrival time and registers it in a local storage device. In addition, the store entry/exit prediction unit 35 predicts an exit time of the user from the facility, and the update/registration processing unit 36 deletes the authentication data from the storage device after the predicted exit time of the user. Thus, the data used for local authentication can be properly managed while maintaining response during authentication.

In other words, in this exemplary embodiment, after the predicted exit time has elapsed, the update/registration processing unit 36 deletes biometric information and payment information stored corresponding to the user ID in the user database 39. Thus, even if face authentication is not performed and even if a certain number of persons do not enter the store, the biometric information and payment information can be deleted, thereby preventing these data from remaining on the store’s device and ensuring privacy. In addition, in this exemplary embodiment, the update/registration processing unit 36 registers the biometric information and payment information of users who have passed the predicted entry time in the user database 39. Thus, the biometric information and payment information of users are maintained in the store’s device only while the user is entering the store, thus ensuring privacy.

In addition, in this exemplary embodiment, registration and deletion of local data is performed based on the time predicted by the store entry/exit prediction unit 35. This makes it possible to dynamically register and delete data.

Next, a variation of this exemplary embodiment is described. The above exemplary embodiment describes a case in which authentication data of users whose arrival is predicted is downloaded from an external device (cloud) and held in a local storage device (user database 39), and a user whose authentication data is not stored in the storage device is judged to be inauthenticatable.

In order to be able to authenticate such users, the collation unit 33 may inquire of the external device whether there is a user who matches the calculated feature. In this case, the external device may be equipped with a configuration equivalent to the collation unit 33 of this exemplary embodiment. This configuration makes it possible to authenticate users for whom no authentication data has been registered in the local storage device.

Next, an overview of the present invention will be described. FIG. 8 is a block diagram showing an overview of a data management system according to the present invention. The data management system 80 (e.g., data management system 100) for managing data of users (e.g., customer) who use a facility (e.g., store), includes: an arrival time prediction unit 81 (e.g., store entry/exit prediction unit 35) which predicts an arrival time (e.g., entry time) of the user at the facility; a registration unit 82 (e.g., update/registration processing unit 36) which acquires authentication data (e.g., biometric information) used for authentication of the user from an external device (e.g., cloud server) based on the predicted arrival time and registers it in a local storage device (e.g., storage server); an exit time prediction unit 83 (e.g., store entry/exit prediction unit 35) which predicts an exit time (e.g., exit time) of the user from the facility; and a deletion unit 84 (e.g., update/registration processing unit 36) which deletes the authentication data from the storage device after the predicted exit time of the user.

Such a configuration allows for proper management of data used for local authentication while maintaining response during authentication.

Specifically, wherein, when the predicted arrival time is reached, the registration unit 82 may acquire authentication data of the user from the external device and register it in the local storage device, and the deletion unit 84 may delete the authentication data from the storage device.

The registration unit 82 may obtain biometric information of the user (e.g., facial features) as the authentication data.

The data management system 80 may further include: a biometric information acquisition device (e.g., camera 10, camera 20) which acquires biometric information of the user; a feature calculation unit (e.g., face detection unit 31, feature calculation unit 32) which calculates a feature of the acquired biometric information; and a collation unit (e.g., collation unit 33) which collates the calculated features with the authentication data stored in the local storage device. Then, the collation unit, when there is a user whose authentication data stored in the local storage device and the calculated feature match, may determine that the user is successfully authenticated.

The registration unit 82 may acquire, together with the authentication data of the user, from the external device payment information which is information on payment of the user, and the deletion unit 84 may delete the authentication data from the storage device together with the authentication data. Such a configuration makes it possible to use the payment information only during the time when authentication is required.

The exit time prediction unit 83 may predict the exit time after the user enters the facility, based on a result of a flow line analysis of the user or a regularity after payment. Such a configuration makes it possible to dynamically predict the exit time based on the user’s movement after entry.

Although the present invention has been described with reference to the foregoing exemplary embodiments and examples, the present invention is not limited to the foregoing exemplary embodiments and examples. Various changes understandable by those skilled in the art can be made to the structures and details of the present invention within the scope of the present invention.

This application is based upon and claims the benefit of priority from Japanese patent application No. 2020-43887, filed on Mar. 13, 2020, the disclosure of which is incorporated herein in its entirety by reference.

### INDUSTRIAL APPLICABILITY

The invention is suitably applied to a data management system that manages locally stored data. For example, the invention can be suitably applied to various systems that operate by downloading personal information from the cloud to devices.

### REFERENCE SIGNS LIST

10, 20 Camera
11 Gate
12 User
21 Payment terminal
30 Control Unit
31 Face detection unit
32 Feature calculation unit
33 Collation unit
34 Gate opening/closing management unit
35 Store entry/exit prediction unit
36 Update/registration processing unit
37 Alarm output unit
38 Time management unit
39 User database
100 Data management system

What is claimed is:

1. A data management system for managing data of users who use a facility, comprising:
a memory storing instructions; and
one or more processors configured to execute the instructions to:
predict an arrival time of the user at the facility;
acquire authentication data used for authentication of the user from an external device based on the predicted arrival time and register it in a local storage device;
predict an exit time of the user from the facility; and
delete the authentication data from the local storage device after the predicted exit time of the user.

2. The data management system according to claim 1, wherein, when the predicted arrival time is reached, the processor is configured to execute the instructions to:
acquire authentication data of the user from the external device and register it in the local storage device; and
the deletion means deletes the authentication data from the storage device.

3. The data management system according to claim 1, wherein the processor is configured to execute the instructions to obtain biometric information of the user as the authentication data.

4. The data management system according to claim 3, wherein the processor is configured to execute the instructions to:
acquire biometric information of the user;
calculate a feature of the acquired biometric information;
collate the calculated features with the authentication data stored in the local storage device; and
when there is a user whose authentication data stored in the local storage device and the calculated feature match, determine that the user is successfully authenticated.

5. The data management system according to claim 1, wherein the processor is configured to execute the instructions to:
acquire, together with the authentication data of the user, from the external device payment information which is information on payment of theuser; and
delete the authentication data from the storage device together with the authentication data.

6. The data management system according to claim 1, wherein
predict the exit time after the user enters the facility, based on a result of a flow line analysis of the user or a regularity after payment.

7. A data management method for managing data of users who use a facility comprising:
predicting an arrival time of the user at the facility;
acquiring authentication data used for authentication of the user from an external device based on the predicted arrival time and registering it in a local storage device;
predicting an exit time of the user from the facility; and
deleting the authentication data from the local storage device after the predicted exit time of the user.

8. The data management method according to claim 7, further comprising:
when the predicted arrival time is reached, acquiring authentication data of the user from the external device and registering it in the local storage device; and
when the predicted arrival time is reached, deleting the authentication data from the storage device.

9. A non-transitory computer readable information recording medium storing a data management program applied to a computer that manages data of users who use a facility, when executed by a processor, the data management program that performs a method for:
predicting an arrival time of the user at the facility;
acquiring authentication data used for authentication of the user from an external device based on the predicted arrival time and registering it in a local storage device;
of predicting an exit time of the user from the facility; and
deleting the authentication data from the local storage device after the predicted exit time of the user.

10. The non-transitory computer readable information recording medium according to claim 9, further comprising:
when the predicted arrival time is reached, acquiring authentication data of the user from the external device and registering it in the local storage device, in the registration processing; and
when the predicted arrival time is reached, deleting the authentication data from the storage device, in the deletion processing.
